(19) United States
(12) Patent Application Publication
(10) Pub. No.: US 2004/0028909 A1
(43) Pub. Date: Feb. 12, 2004

(54) Synthetic composition based on thermosetting resins

(76) Inventors: Peter Clifford Hodgson, Speers Point, NSW (AU); Keith Cyrus Stanistreet, Bonnet Bay, NSW (AU)

Correspondence Address: LADAS & PARRY, 26 WEST 61ST STREET, NEW YORK, NY, 10023, US

(21) Appl. No.: 10/380,335

(22) PCT Filed: Sep. 14, 2001
(86) PCT No.: PCT/AU01/01157

(30) Foreign Application Priority Data
Sep. 14, 2000 (AU) PR 0193
Oct. 4, 2000 (AU) PR 0584

(51) Int. Cl. B32B 27/38; C08L 67/02

(52) U.S. Cl. 428/413; 525/165; 428/500

(57) ABSTRACT

A synthetic composition is described including (i) a clear thermosetting resin selected from the group consisting of unsaturated polyester resins and vinyl functional monomers and oligomers; (ii) at least one metal complex promotor; (iii) at least one UV stabiliser, and (iv) an aliphatic and/or aromatic polyallyl ether pendant monomer or polymer; or (v) a soluble clear thermoplastic resin and/or a wax; or a combination of (iv) and (v). The synthetic composition can be applied to a substrate. A suitable organic peroxide is suitably added prior to or after application to the substrate to facilitate the curing reactions. A primer or build coat may also be present under the synthetic composition.

### TECHNICAL FIELD

The present invention relates to a synthetic composition suitable for application to a surface and a method of applying the synthetic composition to a surface. The invention also relates to a primer composition which is suitably applied on a surface under the synthetic composition. The important features of this invention at least in preferred embodiments are, it is a coating system based on unsaturated polyester/vinyl ester technology. The system suitably comprises the following, substrate preparation, a primer or base coat or both, and a top coat. The system suitably provides, chemical bonding of the finish to the substrate, protection for this chemical bond from the hydrolytic affect of water, and the destructive effects of UV radiation. The system also suitably provides exceptional UV resistance and chemical resistance of the “synthetic composition/top coat”. The system also suitably provides the “synthetic composition/top coat” with exceptional surface cure. The “synthetic composition” is suitably water clear when cured. The top coat comprising the synthetic composition and embedded objects, this combination suitably provide synthetic stone finishes. The surface is resistant to paint solvents and this system has exceptional anti graffiti properties.

### BACKGROUND OF THE INVENTION

It is known to coat surfaces such as concrete pools with a fibreglass surface in which the surface is coated first with a primer, followed by a fibreglass laminate and then by an external pigmented finish coat. Such a pigmented finish coat is of a solid colour having no apparent depth, with only the surface of the gel coat being visible and consequently is similar to a semi gloss house paint. The finish coat is typically formulated from an unsaturated polyester resin, a pigment paste containing a high percentage of titanium dioxide (TiO₂) as opacifier, and a solution of natural and/or synthetic wax dissolved in styrene. The fibreglass laminate underlying layer contributes mechanical strength and chemical resistance to the finish. It is made using fibreglass cloth and a laminating resin. Such fibreglass laminates suffer from the disadvantage that they are expensive, time consuming to prepare, and prone to osmosis if the resin is not rolled into the fibreglass properly. In the fibreglass pool industry, corrosion protection industries, and in boat building, osmosis of the fibreglass composites can be a problem. Osmosis reduces the service life of a fibreglass laminate. One of the prime causes of osmosis is poor laminating.

Other non cementitious coatings suitable for swimming pools include chlorinated rubber based paints and epoxies which are applied directly onto the substrate. Epoxies and chlorinated rubber paints rely on the addition of TiO₂ to augment their UV stabiliser characteristics. If such formulations were applied as clear films without the addition of TiO₂, they would breakdown rapidly under the effect of UV irradiation. Titanium dioxide is an opaque white pigment added to paints to improve their hiding power (ie., preventing the substrate from being seen) and improve their UV resistance. These finishes suffer from the disadvantage that they require reapplication every three to four years and three coats of paint are usually required in order to produce a satisfactory build. Resultant films, however, are less than 500 microns thick.

Other surface coatings include paint. Paint films typically have a build of less than 100 microns, are extremely flexible and adhere to the surface primarily by mechanical means and van der Waals forces. They can be easily chipped and scratched and are usually not suitable for swimming pools.

There is a need for a smooth, attractive, durably synthetic composition which can be applied to a surface such as a swimming pool to enhance the aesthetics thereof and its surrounds.

### OBJECT OF THE INVENTION

It is the object of the present invention to overcome or substantially ameliorate at least one of the above disadvantages or at least provide a suitable alternative.

### SUMMARY OF THE INVENTION

According to a first embodiment of the invention there is provided a synthetic composition including (i) a clear thermosetting resin selected from the group consisting of unsaturated polyester resins and vinyl functional monomers and oligomers; (ii) at least one metal complex promotor; (iii) at least one UV stabiliser; and (iv) an aliphatic and/or aromatic polyallyl ether pendant monomer or polymer; or (v) a soluble clear thermoplastic resin and/or a wax; or a combination of (iv) and (v). A suitable organic peroxide is suitably added suitably immediately prior to or simultaneously with application to facilitate the curing reactions.

According to a second embodiment of the invention there is provided a primer composition including (i) a vinyl ester and (ii) a coupling agent selected from the group consisting of organofunctional silanes or silanols, transition metal mono, di or tri acrylates or methacrylates, and combinations thereof; (iii) at least one metal complex promoter. A suitable organic peroxide is suitably added suitably immediately prior to or simultaneous with application to facilitate the curing reactions. Short reinforcing fibres and pigments may be added if their is no build coat.

According to a third embodiment of the invention there is provided an anti-graffiti finish composition comprising (i) a clear unsaturated polyester thermosetting resin; (ii) a thermoplastic resin and/or a wax, (iii) an aliphatic and/or aromatic polyallyl ether; (iv) at least one metal complex promotor; and (v) at least one UV stabiliser. A suitable organic peroxide is suitably added suitably immediately prior to or simultaneous with application to facilitate the curing reactions.

According to a fourth embodiment of the invention there is provided a process for applying a coating to a surface, said process comprising applying at least one of the compositions according to the first through to third embodiments of the invention. Typically at least two of the composition are applied. A suitable organic peroxide is suitably added suitably immediately prior to or simultaneous with application to facilitate the curing reactions.

According to a fifth embodiment of the invention there is provided a process for applying a coating to a surface, said process comprising applying a primer composition according to the second embodiment of the invention onto a surface, followed by application of the synthetic composition according to the first embodiment of the invention. A suitable organic peroxide is suitably added suitably immediately prior to or simultaneous with application to facilitate the curing reactions.

The fourth or fifth embodiment of the invention may include a build coat composition between the synthetic composition and the primer composition. Typically the build coat comprises an unsaturated polyester or vinyl ester resin suitably promoted and which may be fibre reinforced or pigmented or both. A suitable organic peroxide is suitably added suitably immediately prior to or simulataneous with application to facilitate the curing reactions.

According to a sixth embodiment of the invention there is provided a coated substrate prepared by the process of the fourth or fifth embodiment.

According to a seventh embodiment of the invention there is provided a synthetic composition including (i) a clear thermosetting resin selected from the group consisting of unsaturated polyester resins and vinyl functional monomers and oligomers; (ii) at least one metal complex promoter; and (iii) at least one UV stabiliser.

The coated substrate of the sixth embodiment suitably includes microfibres/short fibres in any or all of the layers for reinforcement and the metal complex promotor is suitably a clear cobalt promoter. The resulting coating when adhered to a suitably prepared substrate is typically UV stable, hydrolytically stable, is a water barrier, has an exceptional surface cure, and the surface is typically transparent/translucent.

### BRIEF DESCRIPTION OF THE DRAWINGS

A preferred form of the present invention will now be described by way of example with reference to the accompanying drawings wherein:

FIG. 1 is a cross-sectional view of a substrate having a synthetic composition of the invention in the form of a synthetic stone gel coat applied thereto;

FIG. 2 is a cross-sectional view of a substrate having a primer in accordance with the invention bonded to a substrate, to which are bonded two layers, a base colour coat followed by a synthetic composition in the form of a synthetic stone gel coat in accordance with the invention;

FIG. 3 is a cross-sectional view of a substrate having a primer in accordance with the invention bonded thereto, followed by a synthetic composition in accordance with the invention in the form of a synthetic stone gel coat;

FIG. 4 is a cross-sectional view of an anti-graffiti coated substrate, the substrate suitably having a primer coat (not shown) applied that chemically bonds to the substrate and forms a secure foundation for a synthetic composition of the invention in the form of a non air inhibited unsaturated polyester clear gel coat. A printed fabric is suitably placed between the primer if present and the synthetic composition.

### DETAILED DESCRIPTION OF THE PREFERRED EMBODIMENTS

The synthetic composition of the invention can be applied as high build surface coatings to produce attractive durable surfaces that can be applied suitably as an architectural finish to concrete surfaces including fibre reinforced concrete products and concrete masonry products and can be applied externally and/or internally. The composition can also be used to suitably coat clay bricks when an effective damp course is present. The composition is particularly suited to surfacing concrete swimming pools. The composition however is also suitable for coating other substrates including fibre boards, synthetic woods, ceramics, plastics, MDF, ply wood, metal including steel and aluminium, and glass. One suitable application is in producing graffiti-proof coatings and graffiti resistant paints with exceptional chemical/solvent resistance suitable for signs such as road safety signs. Such signs are cheaper to manufacture than signs that are currently available and have equivalent reflectivity.

The synthetic composition of the invention suitably includes an inert particulate or fibrous material such that when the composition is cured, an embedded material is suspended therein. Embedding particulates within a polyester matrix is known, however, with unsaturated polyesters, the procedure has always been performed anaerobically against a molded surface. This is because the surface of unsaturated polyesters does not set in the presence of air. Air inhibits the cure by scavenging the free radicals at the surface. The present inventors have developed clear polyester gel coats that are suitably non air inhibited. This is achieved by including a thermoplastic resin and/or wax and/or an allyl polyether as discussed below. Suitably inert particulate or fibrous materials can be included in the composition in amounts typically of up to 50 wt % or more. Suitable inert materials which can be embedded in the cured composition include one or more of the following: printed fabrics, plastic flakes/chips such as PVC, acrylic, polyester, polyethylene or acetyl flakes/chips, pigment micas such as those supplied by Merck, Kemah, Bronson and Jacobs, or Engelhart, glass beads, hologram sparkles, metal flakes/chips, metalized plastic flakes/chips, coloured ceramic flakes/chips or plastic jewels such as AVLO hologram jewels or those sold by Meadowbrook Inventions Inc. The inert material may be coloured or have a pattern printed or marked thereon. Plastic chips can be prepared by grinding plastic feed stock and are suitably less than 2 mm (thickness or diameter), if granular, or less than 5 mm if flaky. Plastic chips are preferred for use in the synthetic composition of the invention as they can be sanded flat after application.

The synthetic composition of the invention suitably forms a translucent/transparent top coat over the substrate to which it is applied. Other layers underlying the top coat may also be present including a primer composition in accordance with the invention and/or a build coat. The build coat when present suitably performs one or more of the following functions: (a) it adheres to the concrete or concrete primer to anchor the synthetic composition particularly when it contains an inert particulate material, (b) it bridges any small voids in the concrete, (c) it forms a secure foundation for the synthetic composition, (d) it protects the concrete resin interface from chemical attack by pool water and the deleterious affect of UV radiation, (e) it contributes to the overall chemical resistance of the coating, (f) it increases the mechanical strength of the coating and (g) provides a background colour for the finish. Suitably, the build coat includes a polyester or vinyl ester such as a toughened epoxy vinyl resin diluted with vinyl functional monomers and oligomers to reduce VOC (volatile organic compounds), especially styrene. Suitably, the build coat is reinforced with milled fibres to improve its mechanical properties and its adhesion and may include fluorocarbon modified resins to eliminate bubble formation which usually occurs when concrete breathes through a freshly painted surface. An inert particulate material such as those discussed above can be included in the build coat instead of in the synthetic composition, or in addition thereto.

The synthetic composition of the invention includes a clear thermosetting resin selected from unsaturated polyester resins and derivatives and vinyl functional monomers or oligomers. The resin is suitably made from “water clear” resins. Water clear resins are made very carefully to minimise oxidation by products during manufacture. These resins have very few chromophores and are inherently much more light stable. In addition the base resin is suitably chosen for its UV stability. UV stabilisers are “band aids”, their overall effectiveness depending on the base resin used. These formulations have been tested by the Queensland University of Technology, in a Suntest Apparatus. All of the formulations tested by the inventors gave vastly superior weathering to the best clear gel coats available at the time. Even non UV stabilized resins gave superior performance to the ones commercially available.

Unsaturated polyesters are most suitable for outdoor applications. Suitably the resin used is UV light stable and is suitably non air inhibited. The characteristics of such resins allow high build, thereby providing surface coatings with a three dimensional quality. Suitable unsaturated polyester resins for use in the invention include chemically resistant unsaturated polyester resins chosen from the group consisting of Eterset 2733 Ortho NPG fumaric acid chemical resistant resin; Eterset 2731 Iso NPG fumaric acid chemical resistant resin; and NAN YA GL316 Iso NPG fumaric acid chemical resistant resin. This is not a comprehensive list of suitable resins.

Water clear casting/embedding unsaturated polyester resins are suitable as a base for general architectural finishes and anti graffiti finishes, they are not necessarily suitable for swimming pool applications. Their suitability depends on hydrolytic stability. Sources for these resins are Craig Mostyn, Pacific Resins and Nuplex Resins, Huntsman etc.. Particularly suitable unsaturated polyester resins include cure in air unsaturated polyester resins such as ROSKYDAL 500A (an air-inhibited unsaturated polyester resin in styrene solution available from Bayer), Viapul VUP4732 SOLUTIA, Viapul UP 527 E/68, Viapul UP 670G, Viapul VUP 4628 E/68, Viapul 4796 E/75 available from Solutia.

A suitable metal complex promotor for use in the synthetic composition of the invention and which may also be included in the primer coats/build coats if present, are metal carboxylate complexes. Typically, cobalt complexes are suitably chosen as the primary promoter for this system so as not to impart colour after curing although the invention is not limited to promotors which do not impart colour however these promotors are desirable in the primer or build coat. A suitable promotor catalyst for use in the invention is cobalt oxalate, or Shen catalyst (a cobalt 2 ethyl hexanoic acid complex catalyst). Cobalt octoate and cobalt naphthenates are less suitable as they impart colour. Other suitable promoters include potassium octoate; zirconium octoate; vanadium naphthenate, copper naphthenate and zinc octoate.

Additional promotors which can be used suitably in the primer and base coat include DMA (N,N-dimethylaniline) and DEA.

To optimise surface cure the synthetic unsaturated polyester compositions of the invention may include “soluble” clear oligomers or polymers including thermoplastic resins such as PMMA (polymethyl methacylate), PS (polystyrene), PE (polyethylene) and polypropylene waxes, ester waxes and other polyesters which are suitably dissolved in dichloromethane, trichloromethane, carbon tetrachloride, dichloroethane or mixtures thereof, and added under suitable conditions. An advantage of using these soluble clear resins is that on solvation of the thermoplastic, the thermoplastic resin exists as loose strands in solution. The solution of thermoplastic is suitably mixed into the unsaturated polyester slowly at temperatures typically below 20° C. taking care not to entrain air during the mixing. By mixing in this way, the thermoplastic entangles in the unsaturated polyester and behaves as a wax during the curing process such that it is squeezed out onto the surface preventing oxygen from scavenging free radicals at the surface and thereby optimising surface cure.

To optimise surface cure the synthetic composition of the invention may include aliphatic, or aromatic polyether allyl pendant monomers and/or polymers such as polyallyl glycidyl ether resins. One suitable resin which can be used is Santolink XI 100 (a 1,2-ethane diol polymer with [(2-propenoxy)methyl]oxirane available from Solutia). These resins breakdown to form peroxides in the presence of oxygen, facilitating surface cure of unsaturated polyesters in the presence of air. They function both as latent initiators for low temperature free radical polymerization, and as highly flexible, multifunctional crosslinkers. These initiators overcome the surface tack or air inhibition problems associated with atmospheric exterior coating applications at ambient temperatures.

A combination of both soluble thermoplastic resin and allyl polyethers are suitably used so as to maximise surface cure, the combination providing the most complete surface cure. Completeness of cure is desirable for optimum performance as concrete swimming pool paints, refurbishing paints for concrete and fibreglass pools, and for anti-graffiti finishes and decorative architectural finishes.

The invention also relates to an anti-graffiti coating which includes the above combination. The unsaturated polyester gel coats formulated with a combination of thermoplastic polymer entrapment and polyallyl ethers produce gel coats finishes which cure in air producing surfaces that are extremely solvent resistant and graffiti resistant and which can tolerate repeated attacks with aerosol paints without any visible damage to the surface. Graffiti proof signs can be prepared by applying the composition of the third embodiment onto a printed paper or fabric with or without an inert particulate or fibrous material such as glass beads, glitter or jewels or combinations. The printed paper or fabric binds to the substrate by resin soaking through the fabric.

Adhesion of the synthetic composition of the invention is achieved by chemical formulation of the composition, and can be further enhanced by physical and chemical modification of the surface of the substrate.

As discussed above, it is desirable that the synthetic composition be applied onto a primer composition or buildcoat, suitably a primer of the second embodiment, which is designed to provide the synthetic composition with maximum adhesion to the substrate by chemically bonding to the surface, sealing the surface and providing a surface on which the build coat if present, or on which the synthetic composition can bond chemically. The primer composition is suitably fibre reinforced to optimise adhesion.

Accordingly the present invention also relates to a primer composition. In its simplest form the primer composition includes in addition to a vinyl ester, coupling agents including organo functional silanes or silanols such as acrylic functional silanes, vinyl functional silanes or styrene functional silanes/silanols; and/or transition metal acrylates or methacrylates, more typically zinc diacrylate. These compounds are able to form chemical bonds with the substrate, in addition to Van der Waal bonds and electrostatic associations, and thereby improve the performance of the coating. Suitable vinyl esters for use as the vinyl esters include flexible epoxy vinyl ester resins. Examples of suitable vinyl ester resins include SYN6311 Cray Valley; F61404-30 NUPLEX; Swancor 980 Toughened VE (a rubber modified vinyl ester resin available from Swancor); Swancor 981 Flexible VE (available from Swancor); or Aromatic Corp flexible VE; Swancor 901 45; Swancor 911 45; Hetron 922; and Derakane 411 45 (an epoxy vinyl ester resin available from Dow).

Fibre reinforcement can be included in the primer composition, the build coat and the synthetic composition as optional ingredients. The fibres suitably toughen the resulting film, improve flowability and levelling, improve adhesion to the substrate by helping to distribute stresses, help the film bridge small voids and imperfections in the substrate, help maintain a uniform film thickness and allow the synthetic composition to be rolled instead of sprayed by locking any suspended particles in the resin matrix. Suitable fibres include, but are not limited to, milled glass fibres, wollastonite fibres or calcined surface treated micas.

Optionally, the primer composition, the build coat and the synthetic composition may include pigments.

For external applications UV absorbers and/or stabilisers are suitably included in any of the primer, build coat or synthetic composition to enhance weatherability. Suitable UV absorbers include HALS (hindered amine light stabilisers), triazols or triazines. Suitable UV absorbers/stabilisers include, but are not limited to, Tinuvin 384 (a triazol), Chimasorb 119FL (a hindered amine) and VP Sanduvor PR31 photograftable HALS available from Clariant.

Additional ingredients which can be included in any of the primer, build coat and synthetic composition include toughening additives such as Sartomer CN962 urethane acrylates, Sartomer CN964 urethane acrylates, Sartomer CN965 urethane acrylates, Hycar reactive liquid polymer 1300X 33 VTBNX, plasticizers such as palamol adipates and dibutylphthalate, thixatropes such as Rheox Thixin E; Rheox Thixatrol+ and fumed silicas such as those supplied by Cabot, Wacker, etc; various treated clays or talc, inhibitors such as acetyl acetone, hydroquinone and tertiary butyl hydroquinone (TBHQ), air release agents such as BYK A515 and 510; Swancor 1317; Bevaloid 6420; and EFKA20, levelling agents such as EFKA 777 or other proprietary products; catalysts or initiators such as MEKP or other organic peroxide; CHP and benzoyl peroxide, fillers such as zenospheres; PVC powder; treated organo clays; talc; calcium carbonates or silicate minerals, and antibubbling agents such as fluorocarbon modified resins.

The resins in any of the primer, build coat and synthetic composition may be diluted with a monomer such as styrene or methyl methacrylate monomer to adjust the rheology.

The compositions are suitably applied by brushing, rolling or spraying the compositions onto the surface to be treated. More than one build coat can be applied. A suitably fibre reinforced build coat is suitably applied to the primed surface to add mechanical strength to the finish. The films can be applied thickly, one pass with a polyester allows film builds of up to 1500 microns with a minimum thickness typically of about 300 microns (stiffness increasing by the cube of the thickness—this is why chemical bonding is most desirable). By using multiple coats, a cladding can be built directly onto the substrate. If the substrate has a poor surface that could fail during service, then in order to keep the paint/cladding attached, the cladding can be fastened to the substrate using conventional fasteners.

Prior to applying the composition to the substrate it is desirable that the surface of the substrate be suitably prepared. This is particularly important when the substrate is cementitious concrete or masonry. As styrene (which can be included in the synthetic composition) is an aggressive solvent, all paint should suitably be removed prior to coating.

Depending on the application there are a number of ways and combinations in which the synthetic composition of the invention may be applied. The following schematic diagram shows how compositions of the invention can be applied for various applications:

[image]

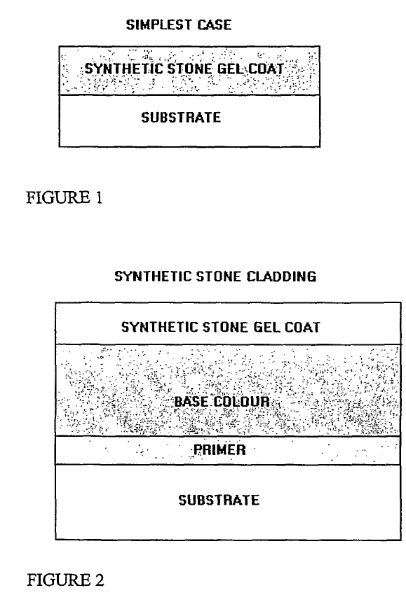

In a first process, process 1 which is suitably for interior applications where there is no possibility of moisture, a synthetic stone gel coat in accordance with one embodiment of the invention is directly applied to a suitably thoroughly cleaned and optionally chemically treated substrate (see FIG. 1).

In a second process, process 2 which is suitably for exterior applications where there is minimal moisture, a reinforcing substrate base colour coating composition is applied to a thoroughly clean and optionally chemically treated substrate, followed by application of a synthetic stone gel coat in accordance with one embodiment of the invention (see FIG. 2).

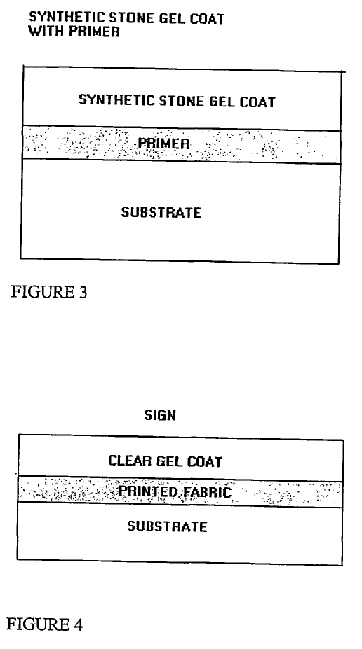

In a third process, process 3 which is suitably for exterior applications where there is moisture an optional sealer primer composition in accordance with one embodiment of the invention is applied, followed by a reinforcing substrate base colour to which is applied a synthetic stone gel coat in accordance with one embodiment of the invention (see FIG. 3)

Not schematically shown is the procedure for making a sign. In this procedure a suitable substrate is chosen to which is applied a printed fabric followed by a synthetic composition in accordance with the invention (see FIG. 4) which includes a polyallyl ether and a soluble thermoplastic resin.

The compositions of the invention are not paints but are high build surface coatings that effectively form a cladding which is adhered to the surface by chemical bonds. Bonding the finish to the substrate is essential because the coating system has real substance and considerably more mass than paint. Each layer of the finish has five to fifteen times the build of a normal architectural paint. Suitably it is bonded to the surface permanently otherwise it may fall off in sheets. Another reason why chemical bonding of the finish to the substrate is desirable is shrinkage of the film during curing. Such shrinkage occurs in the film, not the substrate, and considerable forces are generated at the interface. These forces can be strong enough to tear the surface off plate glass. If there is not a chemical bond between the substrate and the film, poor adhesion is guaranteed. Van der Waals forces are not sufficient to bond the synthetic composition to the substrate. Sufficient bonding to the substrate can be achieved by employing organofunctional silanes and silanols and/or transition metal acrylates in the primer composition. By using these materials chemical bonds, coordination bonds and ionic bonds can be formed between the substrate and the primer (particularly between metal or silicate minerals) which is augmented by hydrogen bonding provided by the hydroxyl groups in the epoxy vinyl ester.

Depending on the particulate or fibrous material used, when these coatings are applied onto a surface they can produce a synthetic stone appearance, or highly reflective finish, a sparkling finish, or a three dimensional finish. All these finishes are possible because they are comprised of particles suspended in a clear matrix and the underlying build coats are visible. The actual appearance of the finish produced depends on the thickness of the clear matrix, the type of particles suspended, the orientation of the particles, the method of application, and the direction and characteristics of the ambient light.

Polyester and vinyl ester resins are 100% solids which allows very thick film builds per pass. It is the high build character, exceptional transparency/clarity, and excellent UV resistance, surface cure, hydrolytic stability and water resistance, that allows one to formulate synthetic stone finish coats, reflective finish coats, cloud finish flow coats, opal finish flow coats, synthetic pearl finishes, and moon-scape gel coats, that can be used for external coatings, swimming pool coatings, and anti-graffiti finishes by adding particulate matter to the clear gel coat. The surface is attractive, smooth and durable and can last for over 10 years without the need for reapplication. The method of the invention when incorporating fibres does not require laminating, thereby eliminating or minimising osmotic breakdown. The resin also has the ability to resist the oxidation caused by the presence of free and bound chlorine in swimming pool water. The coatings are clear, have a glossy glass-like water-clear appearance and are typically glass clear to a depth of about 700 microns for thixatropic products and about 10 mm for non thixed films. The coatings typically have low moisture permeability and for practical purposes are a complete barrier to water. Typical MVTRs (moisture vapour transfer rates) are of the order of less than 1.0 mg of water/m²/day.

### EXAMPLES

The invention will now be described with reference to the following examples:

A Concrete Swimming Pool Finish

A swimming pool finish is one suitable application of the synthetic composition of the invention. Swimming pools typically require exceptional surface cure to resist the chemical attack of swimming pool water. In applying the synthetic composition of the invention to swimming pools, the use of a primer coat is essential to guarantee excellent adhesion to the substrate and also to isolate the interface from the hydrolytic effects of pool water. The interface is suitably further protected by the build coat. The interface between the substrate and the coating is suitably not subject to hydrolysis and the bond between the substrate and the swimming pool coating desirably needs to be optimised as unsaturated polyester resins shrink when they cure, thereby stressing the bond between the coating and the substrate.

Concrete finishes are particularly susceptible to adhesive failures in service unless specific attention is paid to preparing the concrete surface. In applying the method of the invention the pool concrete surface is desirably at least 14 days old and suitably has a compressive strength of at least 25 MPa Old concrete and fibreglass pools may require additional surface preparation depending on their condition. It is desirable to remove all traces of laitance and expose clean siliceous aggregate. Mechanical/physical methods may be used, however the best methods are either high pressure water blasting (typically at least 3,000 psi) or acid washing the surface of the concrete with a 5-10% solution of hydrochloric acid, followed by washing with water, then with a saturated sodium bicarbonate solution, followed by another water wash. The sodium bicarbonate is used to neutralize residual acid.

If there is any perceived problem with moisture in the concrete, then the prepared concrete surface is also desirably treated with a sealer to seal the surface and aid adhesion of the primer coat. A suitable sealer is a buffered aqueous solution or aqueous dispersion of 0.5 to 10 wt % of an organo functional silane. Another suitable sealer is a thixed and promoted unsaturated polyester/vinyl ester composition containing metal diacrylates and/or silanes. Incorporation of a metal diacrylate such as zinc diacrylate at 5 to 25% total monomer content in the sealer used, aids adhesion, both to the coupling agent in the primer and to SiO₂ present in the concrete.

The surface of the concrete is then suitably dried to less than 8%-8.5% moisture. When the surface is dry and free of loose material it is ready for coating with the primer. Suitably the pool is protected from the weather and prevented from getting wet during application of the various coats. This can be achieved by covering the application area with a tarpaulin. Then the whole surface is painted either by brush, roller or spray with a low viscosity vinyl ester primer. A suitable primer composition can be made as follows:

| | |
|---|---|
| Epoxy vinyl ester base resin depending on | 30-70 parts |
| monomer content | |
| Zinc diacrylate | 1-25 parts |
| Monomer content (eg styrene) | 27-67 parts |
| Silane coupling agent | 0.5-10 parts |
| Cobalt Promoter 6% active cobalt in | 0.2-1.5 parts |
| solution | |
| Dimethyl aniline or equivalent | 0.001-0.1 parts |
| Acetyl acetone (2,4 pentane dione) | 0-0.25 parts |
| Anti bubbling agents | 0-2.0 parts |
| Thixatropic agents | 1-10 parts |

Parts are parts by weight.

If applied this coat is suitably immediately followed by application by brush, roller or spray of the base coat.

The base coat is suitably a fibre reinforced, thixatropic and pigmented epoxy vinyl ester resin although an unsaturated polyester resin can be used. The fibre reinforcement adds mechanical strength, helps flow properties, aids adhesion, and improves coverage by bridging small voids. A suitable base coat chosen to add up to 100 parts can be formulated as follows:

| | |
|---|---|
| Ortho, Iso, Terephthalate, or EVE and/or | 30-70 parts |
| hydrogenated UP resins and mixtures | |
| Monomer content (eg styrene) | 27-67 parts |
| Reinforcing fibre content | 5-30 parts |
| Cobalt Octoate 6% active cobalt in solution | 0.2-0.6 parts |
| Dimethyl aniline or equivalent | 0-0.3 parts |
| Acetyl acetone | 0-0.3 parts |
| Anti bubbling agents | 0-2.0 parts |
| Thixatropic agents | 0-10 parts |
| Pigments | 1-30 parts |
| Self levelling agents | 0-5 parts |

Parts are parts by weight.

The base coat is designed to form an excellent base for the synthetic stone gel coat and to protect the interface between the pool and the coating from the hydrolytic attack of swimming pool water. Its colour also adds to the overall aesthetic appearance of the coating.

Once the base coat is applied, a synthetic stone gel coat that forms the cosmetic surface can be sprayed, brushed or rolled, onto the base coat in the same way paint is applied. Because the resin matrix of the synthetic stone gel coat typically has less than 5% mineral fillers it has superior hydrolytic stability to filled gel coat systems. The synthetic stone gel coat offers an effective water barrier, further protecting the finish.

When applied by spraying, any pot catalysed, external, or internal mix spray gun system that can be operated on site and that are suitably designed for spraying unsaturated polyester resins can be used. The spray gun may require modification to handle any suspended particulate/fibrous materials. A suitable synthetic composition/synthetic stone gel coat base can be formulated as follows:

| | |
|---|---|
| Ortho, Iso, or Terephthalate and | 30-70% |
| hydrogenated unsaturated polyester resins | |
| and mixtures | |
| Poly allyl ether | 5-50% |
| Thermoplastic resin and or waxes | 0-5.0% |
| Monomer addition (eg styrene) | 10-50% |
| Reinforcing fibre content | 0-30% |
| Cobalt Promoter 6% active cobalt in | 0.1-1.0% |
| solution Shen or Cobalt oxalate | |
| Co promoters either metal salts, or Lewis | 0-0.5% |
| acids | |
| Hindered phenols | 0-0.25% |
| Anti bubbling agents | 0-1.0% |
| Thixatropic agents | 0-3% |
| Pigments | 0-5% |
| Self levelling agents | 0-5% |
| UV stabilizers HALS and UV absorbers | 0.5-5% |

Percentages are weight percent.

To this synthetic composition/synthetic stone gel coat base, various additives can be added in an amount up to 50 wt % or more so as to obtain various textures/finishes. For example

(a) for a synthetic stone gel coat the
following can be combined:

| Synthetic stone gel coat base (as above) | 20% to 90% |
|---|---|
| Coloured Plastic or ceramic chips | 1% to 50% |
| Micas | 0 to 10% |
| Transparent Pigments | 0% to 10% |
| Opaque Pigments | 0% to 5% |
| Short Fibres | 5% to 30% |
| An optional base colour may be applied under the | |
| synthetic stone gel coat prior to application | |
| OR | |
| Synthetic stone gel coat base (as above) | 50% to 99% |
| Coloured Plastic or ceramic chips | 0 to 50% |
| Micas | 0 to 10% |
| Transparent Pigments | 0 to 10% |
| Glitter, jewels, hologram jewels | 0.5% to 10% |
| Short Fibres | 5% to 30% |

an optional base colour may be applied under the
synthetic stone gel coat prior to application

(b) for a cloud finish/opal finish the
following can be combined:

| | |
|---|---|
| Synthetic stone gel coat base (as above) | 50% to 99% |
| Coloured Plastic or ceramic chips | up to 50% |
| Micas | up to 10% |
| Transparent Pigments | up to 10% |
| Surface tension modifiers | 0% to 5% |

(c) for a reflective finish the following can be combined:

| | |
|---|---|
| Synthetic stone gel coat base (as above) | 50% to 99% |
| Micas | up to 10% |
| Transparent Pigments | up to 10% |
| Glitter, jewels, hologram jewels | up to 10% |
| Glass beads | up to 50% |

Multiple applications of each coat (primer, build coat and synthetic gel coat) can be made if desired and the particulate matter is not necessarily included in the synthetic gel coat but may instead or in addition be included in the build coat in similar ranges as above. The primer and build coats can be applied wet on wet. The synthetic gel coat is suitably applied once any previous layers that have been applied have tacked.

Suitably up to 5 wt % of an organic peroxide is added prior to or simultaneous with application of each coat to facilitate the curing reactions. The organic peroxide can be added to each coat on application.

### Formulation Examples

Sealer Coat

```
  0.1 parts emulsifier - sulfonate surfactant
  5 parts silane acrylate coupling agent
  95 parts water.
If this product is stored before use it is typically
buffered to pH 3 using acetic acid
```

Primer coat

| | |
|---|---|
| 65 parts Swancor 901 35 | bisphenol A type vinyl |
| | ester resin |
| 30 parts styrene monomer | monomer |
| 2.3 parts Wacker HDK H18 (fumed silica) | thixatrope |
| 0.5 parts cobalt octoate | promotor |
| 0.1 part DMA (N,N-dimethylaniline) | promotor |
| 0.05 parts acetyl acetone | inhibitor |
| 2 parts silane acrylate coupling agent | coupling agent |
| 5 parts zinc diacrylate. | coupling agent |

Build coat

| | |
|---|---|
| 65 parts Swancor 901 35 | bisphenol A type vinyl |
| | ester resin |
| 30 parts styrene monomer | monomer |
| 2.3 parts Wacker HDK H18 (fumed silica) | thixatrope |
| 0.5 parts cobalt octoate | promotor |
| 0.1 part DMA (N,N-dimethylaniline) | promotor |
| 0.05 parts acetyl acetone | inhibitor |
| 5 parts pool blue pigment paste | pigment |
| 20 parts wollastonite fibres | reinforcing fibres |

Finish Coat/synthetic stone gel coat

| | |
|---|---|
| 65 parts Viapal VUP4732 | unsaturated polyester |
| 30 parts styrene | monomer |
| 2.5 parts Wacker HDK H18 (fumed silica) | thixatrope |
| 0.35 parts Shen catalyst | promotor |
| 0.2 parts potassium octoate | promotor |
| 6 parts (20% PMMA polymer solution | thermoplastic resin |
| in dichloroethane) | |
| 2 parts Tinuvin 384 (triazol) | UV stabiliser |
| 2 parts Chimasorb 119FL (HALS) | UV stabiliser |
| 12 parts light blue pvc chips | particulate material |
| 3 parts mica sparkle (Mearl Exterior Sparkle) | particulate material |
| 3 parts silver hologram sparkles | particulate material |

The formulations can be made by adding each ingredient to a mixing tank and blending at different shear rates by use of a suitably high speed disperser. The product is then suitably tested and if it passes, is suitably packed into suitable containers and labelled prior to shipping.

1. A synthetic composition including (i) a clear thermosetting resin selected from the group consisting of unsaturated polyester resins; (ii) at least one metal complex promoter; (iii) at least one UV stabiliser; and (iv) an aliphatic and/or aromatic polyallyl ether pendant monomer or polymer; or (v) a soluble clear thermoplastic resin and/or a wax; or a combination of (iv) and (v).

2. A synthetic composition according to claim 1 wherein the thermosetting resin is an unsaturated polyester resin.

3. A synthetic composition according to claim 1 wherein the at least one metal complex promoter contains cobalt.

4. A synthetic composition of claim 1 wherein the polyallyl ether is a polyallyl glycidyl ether resin.

5. A synthetic composition of claim 1 wherein the soluble clear thermoplastic resin and/or wax is an ester wax or other polyester.

6. A synthetic composition of claim 1 further including reinforcing fibres.

7. A synthetic composition of claim 1 further including an inert particulate or fibrous material.

8. A primer composition including (i) a vinyl ester and (ii) a coupling agent selected from the group consisting of organofunctional silanes or silanols, transition metal mono, di or tri acrylates or methacrylates, and combinations thereof.

9. A primer composition according to claim 8 further including reinforcing fibres.

10. An anti-graffiti finish composition comprising (i) a clear unsaturated polyester thermosetting resin; (ii) a thermoplastic resin and/or a wax, and (iii) an aliphatic and/or aromatic polyallyl ether.

11. A process for applying a coating to a surface comprising applying the compositions according to the claim 1, 8 or 10 to the surface.

12. A process for applying a coating to a surface comprising applying a primer composition according to claim 8 onto a surface, followed by application of the synthetic composition according to claim 1.

13. A process according to claim 12 further including applying a build coat composition between the synthetic composition and the primer composition.

14. A process according to claim 13 wherein the build coat includes a fibre reinforced promoted pigmented vinyl ester or unsaturated polyester resin.

15. A coated substrate prepared by the process of claim 11, 12, 13 or 14.

16. A synthetic composition including (i) a clear thermosetting resin selected from the group consisting of unsaturated polyester resins and vinyl functional monomers and oligomers resins; (ii) at least one metal complex promotor; and (iii) at least one UV stabiliser.
